(19) United States
(12) Patent Application Publication
(10) Pub. No.: US 2026/0268064 A1
(43) Pub. Date: Sep. 10, 2026

(54) HALLUCINATION MITIGATION WITH LLM-MLLM COLLABORATION

(71) Applicant: ADOBE INC., SAN JOSE, CA (US)

(72) Inventors: Saehyung Lee, Seoul (KR); Seunghyun Yoon, San Jose, CA (US); Trung Huu Bui, San Jose, CA (US); Jing Shi, San Jose, CA (US)

(21) Appl. No.: 19/071,990

(22) Filed: Mar. 6, 2025

(51) Int. Cl. G06F 40/166; G06F 40/205

(52) U.S. Cl. CPC G06F 40/166; G06F 40/205

(57) ABSTRACT

A method, apparatus, non-transitory computer readable medium, and system for reducing hallucinations in visual captions includes obtaining an image and an input caption for the image. An image perception system then decomposes the input caption into a plurality of partial captions, where each partial caption can be independently verified to detect hallucinations. Each of the plurality of partial captions includes a portion of the input caption. The system then generates an output caption for the image based on the plurality of partial captions, where portions identified as hallucinations are excluded. The output caption excludes the portion of the input caption corresponding to a partial caption of the plurality of partial captions.

### BACKGROUND

The following relates generally to image processing, and more specifically to image captioning. Image processing is a type of data processing that involves the manipulation of an image to get the desired output, typically utilizing specialized algorithms and techniques. It is a method used to perform operations on an image to enhance its quality or to extract useful information from it. This process usually comprises a series of steps that includes the importation of the image, its analysis, manipulation to enhance features or remove noise, and the eventual output of the enhanced image or salient information it contains.

Image captioning is a relatively recent task in image processing that involves interpreting image data with a model to generate words that describe the image. This process typically combines computer vision techniques to analyze the image content with natural language processing to generate descriptive text. Modern image captioning systems often use deep learning models, particularly neural networks, which are trained on large datasets of image-text pairs to learn the relationship between visual features and textual descriptions. In some cases, models can generate hallucinations, which in the case of image captioning refers to the generation of descriptions that include objects or actions that are not actually present in the image.

### SUMMARY

Embodiments of the present inventive concepts include systems and methods for reducing hallucinations in image captioning. Embodiments include a language generation model configured to decompose an initial caption of an image into partial captions, where each partial caption includes one element from the initial caption. Then, each partial caption is input, along with the image, into a multimodal language model to determine if the element from the partial caption is present in the image. This approach, referred to herein as “isolation,” has greatly increased accuracy when compared to evaluating an image against a single lengthy caption with multiple elements. The multimodal language model generates a true or false label that indicates whether or not the element was in the image. Then, a corrector model generates a corrected caption by excluding the hallucinated elements.

A method, apparatus, non-transitory computer readable medium, and system for image captioning are described. One or more aspects of the method, apparatus, non-transitory computer readable medium, and system include obtaining an image and an input caption for the image; decomposing, using a language generation model, the input caption into a plurality of partial captions, wherein each of the plurality of partial captions includes a portion of the input caption; and generating an output caption for the image based on the plurality of partial captions, wherein the output caption excludes the portion of the input caption corresponding to a partial caption of the plurality of partial captions.

A method, apparatus, non-transitory computer readable medium, and system for image captioning are described. One or more aspects of the method, apparatus, non-transitory computer readable medium, and system include obtaining an image and an input caption for the image; generating, using a multimodal language model, a hallucination label corresponding to a portion of the input caption; and generating an output caption for the image based on the hallucination label, wherein the output caption excludes the portion of the input caption.

An apparatus, system, and method for image captioning are described. One or more aspects of the apparatus, system, and method include a memory component; a processing device coupled to the memory component, the processing device configured to perform operations comprising: obtaining an image and an input caption for the image; decomposing, using a language generation model, the input caption into a plurality of partial captions, wherein each of the plurality of partial captions includes a portion of the input caption; and generating an output caption for the image based on the plurality of partial captions, wherein the output caption excludes the portion of the input caption corresponding to a partial caption of the plurality of partial captions.

### BRIEF DESCRIPTION OF THE DRAWINGS

FIG. 1 shows an example of image processing system according to aspects of the present disclosure.

FIG. 2 shows an example of image processing apparatus according to aspects of the present disclosure.

FIG. 3 shows an example of a transformer architecture according to aspects of the present disclosure.

FIG. 4 shows an example of a pipeline for fact-checking according to aspects of the present disclosure.

FIG. 5 shows an example of a pipeline for assembling a corrected caption according to aspects of the present disclosure.

FIG. 6 shows an example of a pipeline for correcting an initial caption using LLM-MLLM collaboration according to aspects of the present disclosure.

FIG. 7 shows an example of a method for removing hallucinations from an initial caption according to aspects of the present disclosure.

FIG. 8 shows an example of a data generation pipeline for training data and evaluation data according to aspects of the present disclosure.

FIG. 9 shows an example of evaluation metrics of different hallucination detection methods according to aspects of the present disclosure.

FIG. 10 shows an example of a step-by-step algorithm for training ML models according to aspects of the present disclosure.

FIG. 11 shows an example of a computing device according to aspects of the present disclosure.

### DETAILED DESCRIPTION

Image processing techniques, such as image generation, are frequently used in creative workflows. Historically, users would rely on manual techniques and drawing software to create visual content. The advent of machine learning (ML) has enabled new workflows that automate the image creation process.

ML is a field of data processing that focuses on building algorithms capable of learning from and making predictions or decisions based on data. It includes a variety of techniques, ranging from simple linear regression to complex neural networks, and plays a significant role in automating and optimizing tasks that would otherwise require extensive human intervention.

Image captioning is one application of image processing that combines computer vision and natural language processing to generate textual descriptions of images. This process typically involves analyzing visual features within an image and translating them into human-readable text. Modern image captioning systems often utilize multimodal large language models (MLLMs), which can process both image and text data simultaneously to generate detailed descriptions.

However, MLLMs may exhibit a phenomenon known as “hallucination” when generating image captions. Hallucination occurs when the model includes objects, actions, or relationships in the caption that are not actually present in the image. This issue becomes more pronounced as captions become longer and more detailed, as the model tends to rely increasingly on its learned language patterns rather than the actual image content. As a result, the accuracy and reliability of image captions can be impaired when relying on a standard MLLM.

Recent image captioning systems have incorporated multimodal large language models that can process both visual and textual information. These systems can generate more detailed and extensive captions compared to traditional captioning models. However, as captions become longer and more detailed, these systems tend to generate hallucinations more frequently, particularly when describing objects or relationships that are not present in the input image.

Typical approaches to address hallucination in image captioning include several categories of solutions. Some conventional methods modify the model's decoding process to reduce the likelihood of generating hallucinated content. Other approaches focus on training techniques, such as using specially curated datasets that include examples of what is not present in images. Still other conventional systems employ additional models to detect and correct hallucinations after they are generated.

However, conventional hallucination detection methods become less effective as caption length increases. This decrease in effectiveness may result from the captioning system's increasing reliance on its own generated text rather than the input image as the caption grows longer. Conventional detection methods, which rely on categorizing hallucinations using token probabilities sampled from later generations in lengthy captions, or that rely on consistency checks across multiple caption generations, show diminished performance beyond certain caption lengths.

Embodiments of the present disclosure improve the accuracy of image captioning systems by implementing a framework for detecting and correcting hallucinations. The framework includes a language generation model configured to decompose an initial caption of an image into partial captions, where each partial caption includes one element from the initial caption. Then, each partial caption is input, along with the image, into a multimodal language model to determine if the element from the partial caption is present in the image. This approach, referred to herein as “isolation,” has greatly increased accuracy when compared to evaluating an image against a single lengthy caption with multiple elements. The multimodal language model generates a true or false label that indicates whether or not the element was in the image. Then, a corrector model generates a corrected caption by excluding the hallucinated elements. This decomposer-verifier-corrector framework can be implemented with any combination of language models and multimodal language models, making it adaptable as new models are developed.

The present embodiments are effective for detailed image captioning tasks especially where conventional approaches become less reliable. Embodiments can be readily integrated into existing image processing workflows to enhance the accuracy of generated captions. The improved accuracy of image captions generated using embodiments described herein enables various practical applications, including accessibility features for visually impaired users and the generation of high-quality training datasets for machine learning systems.

As used herein, a “partial caption” may refer to an atomic proposition based on an initial caption, where the proposition is either true or false. For example, when embodiments decompose an input caption such as “the image depicts a house with a red roof and a chimney” into partial captions, the partial captions may include: “the house has a red roof”, and “the house has a chimney”. Embodiments may utilize a large language model (LLM) to decompose the initial caption into atomic captions, though embodiments are not necessarily limited thereto, and other natural language processing (NLP) techniques may be used such as dependency parsing to identify subject-object relationships, constituency parsing to break down sentences into their grammatical components, semantic role labeling to identify actions and their participants, named entity recognition to identify specific objects and their attributes, and rule-based systems that identify conjunctions and lists within the caption text. Additionally, some embodiments may employ statistical methods such as co-occurrence analysis or pattern matching using regular expressions to identify distinct elements within the caption.

As used herein, a “hallucination label” indicates whether the element included in the partial caption is likely a hallucination, that is, not a part of the image. For example, the hallucination label for a partial caption may be “True”, indicating that the element is likely present in the image, or “False”, indicating that the element (as obtained from the initial caption) was likely hallucinated and is not present in the image. Other labels may be used to indicate the predicted hallucination status of the image, like “Hallucinated” or “Not Hallucinated”, “Likely Present”, “Likely Hallucinated”, or similar.

As used herein, a “hallucination score” refers to a scalar value that indicates the likelihood that the element recited in the partial caption is a hallucination. In some embodiments, a higher hallucination score may indicate a higher probability that the element in the partial caption and the corresponding element from the initial caption was hallucinated when the image was initially captioned.

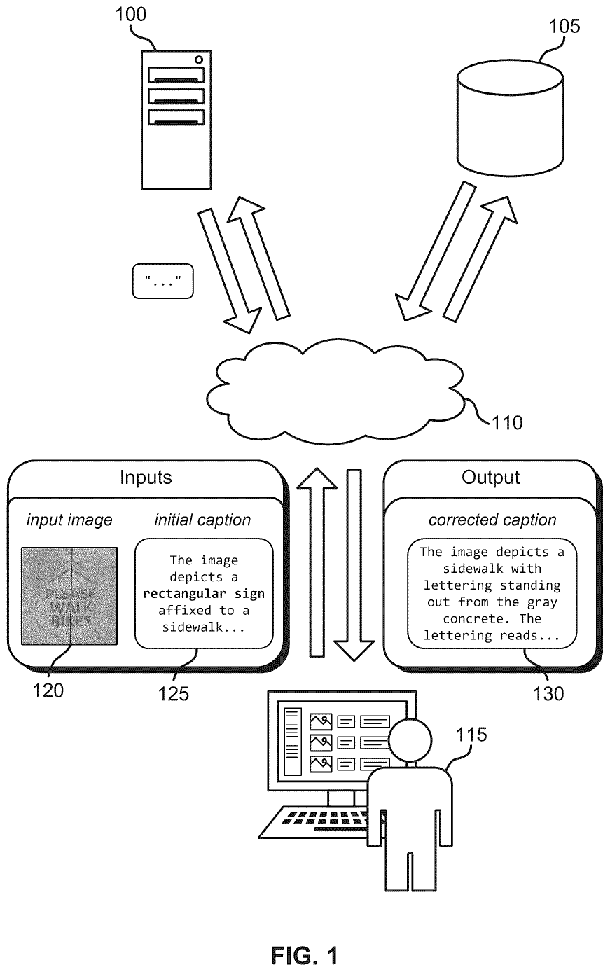

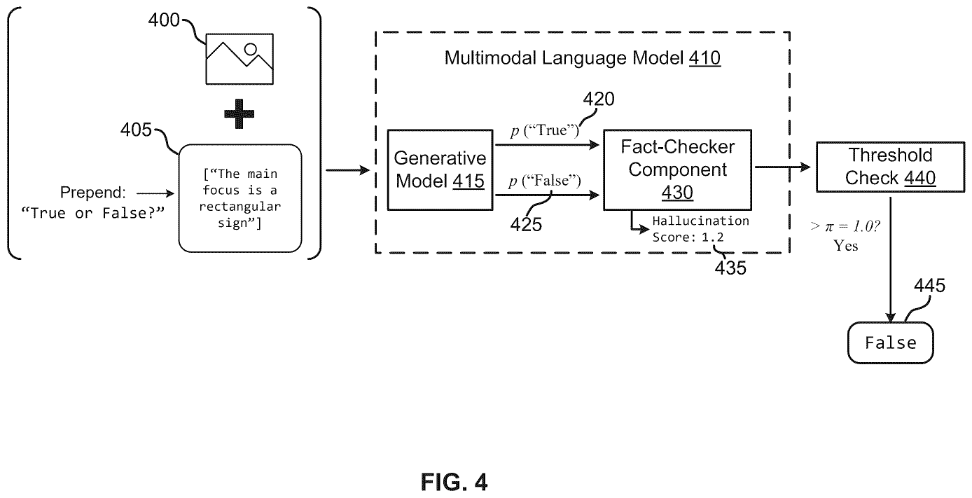

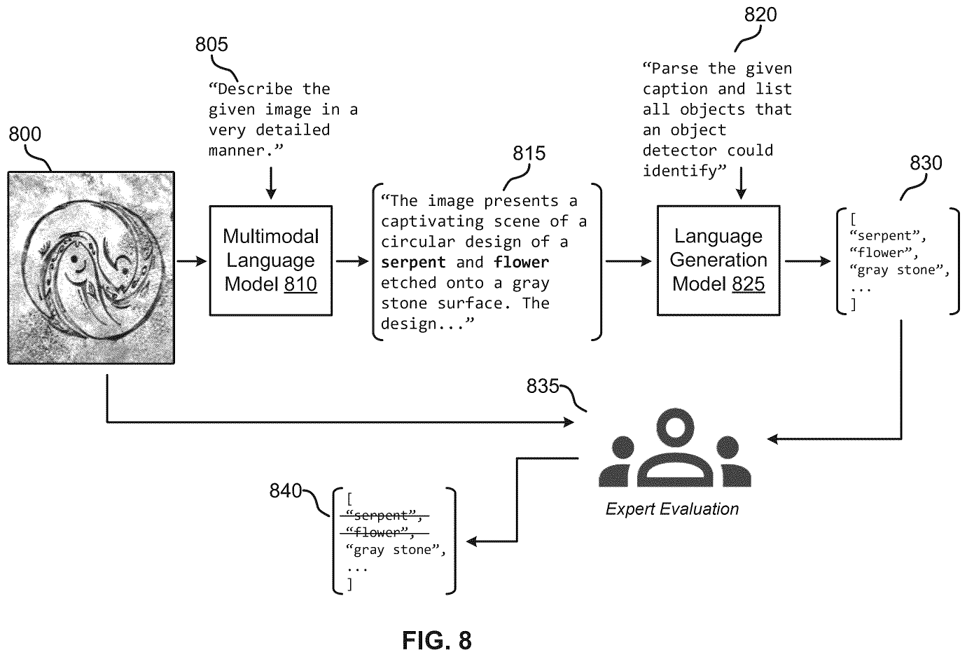

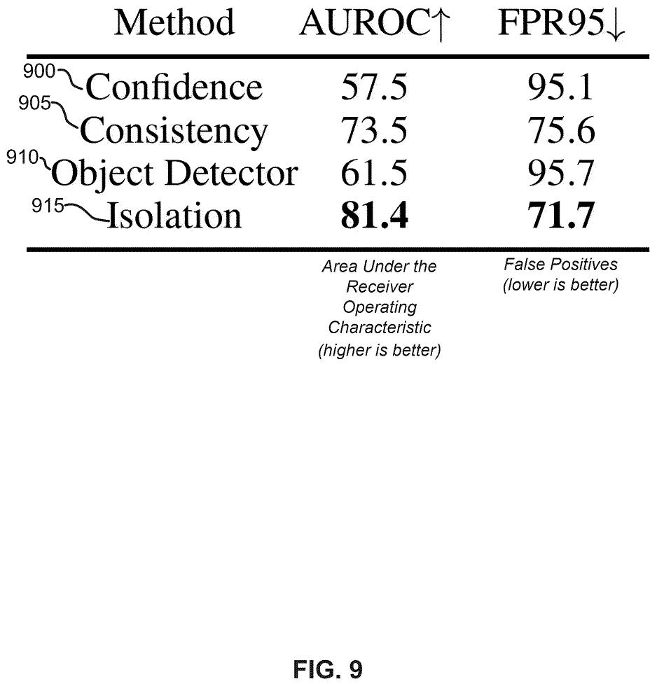

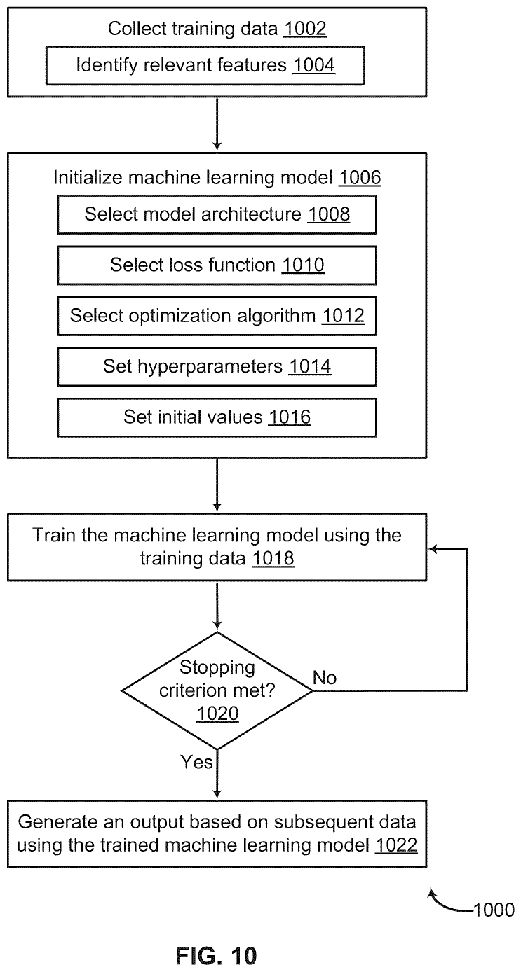

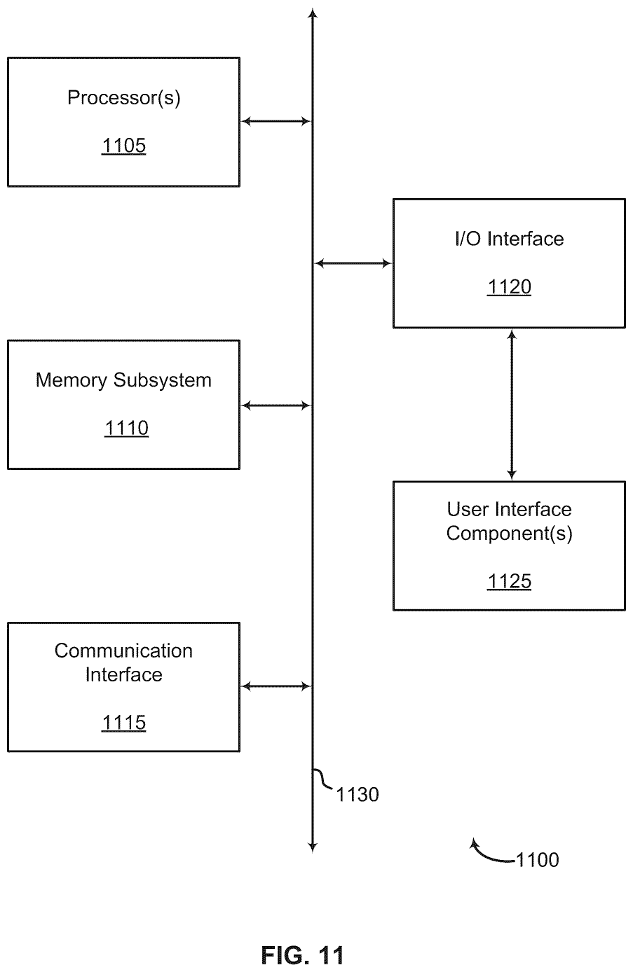

An image processing system for reducing hallucinations in visual captions is described with reference to FIGS. 1-3. Pipelines and methods for reducing hallucinations are described with reference to FIGS. 4-7. A method for generating ground-truth data for training machine learning models and for evaluating the performance of image processing systems, as well as evaluation results, are described with reference to FIGS. 8-9. A method for training a machine learning model configurable to implement one or more components of an image processing apparatus is described with reference to FIG. 10. A computing device configured to implement the image processing apparatus is described with reference to FIG. 11.

### Image Processing System

FIG. 1 shows an example of an image processing system according to aspects of the present disclosure. The example shown includes image processing apparatus 100, database 105, network 110, user 115, image 120, initial caption 125, and corrected caption 130.

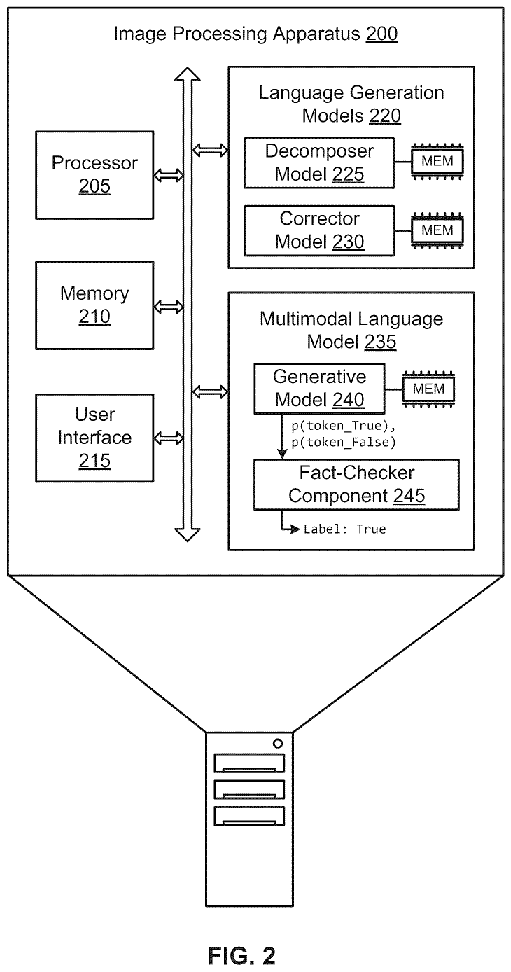

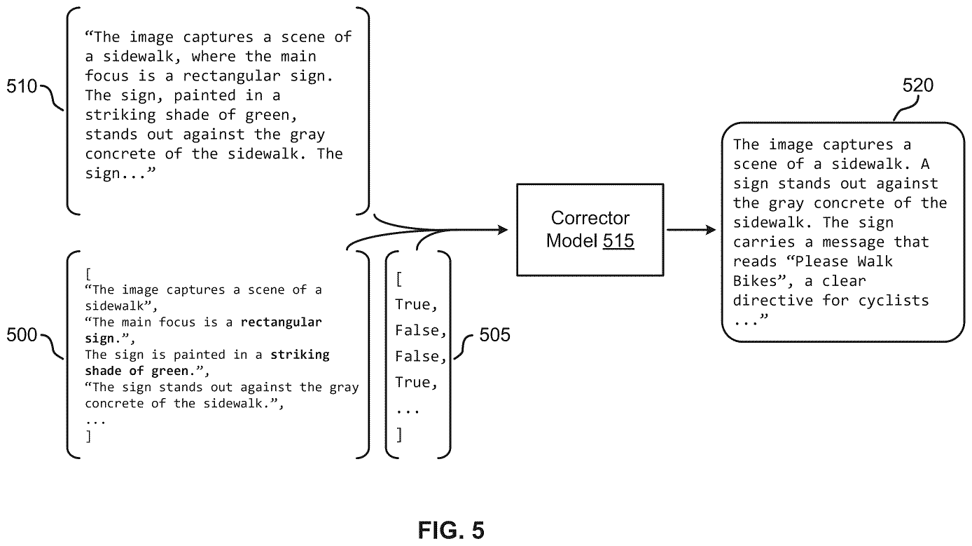

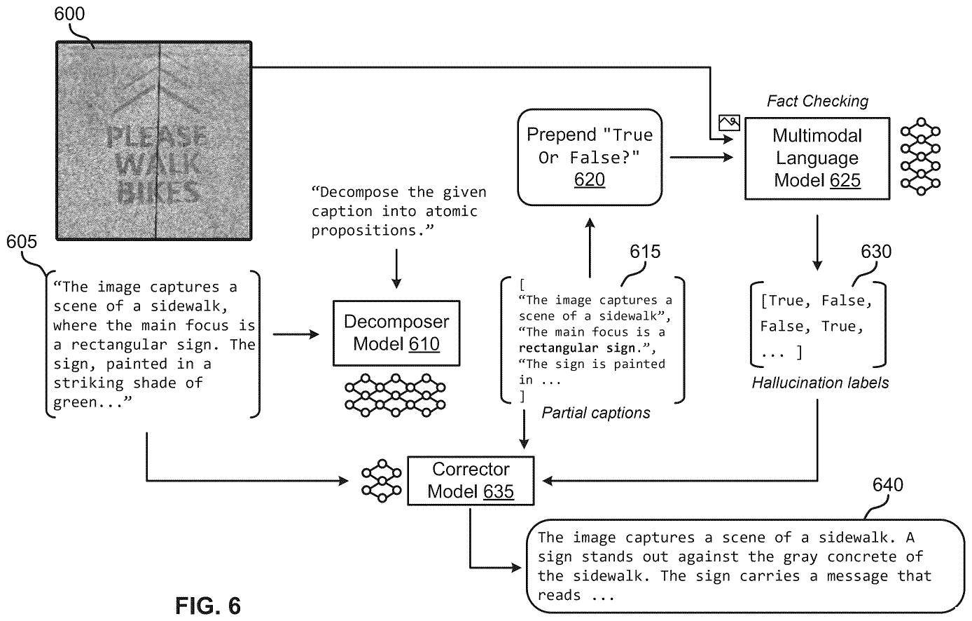

Image processing apparatus 100 is an example of, or includes aspects of, the corresponding element described with reference to FIG. 2. Image 120 is an example of, or includes aspects of, the corresponding element described with reference to FIGS. 4, 6, and 8. Initial caption 125 is an example of, or includes aspects of, the corresponding element described with reference to FIGS. 5 and 6. Corrected caption 130 is an example of, or includes aspects of, the corresponding element described with reference to FIGS. 5 and 6.

In an example process, the system receives inputs including image 120 and initial caption 125. The system may receive the inputs from, e.g., user 115, or an external system. The initial caption 125 is a text that describes the contents of the image 120. The initial caption 125 may have been previously generated by, for example, a vision-language model, and may include hallucinations. Image processing apparatus 100 then processes the initial caption 125 by decomposing it into partial captions, and checking each partial caption with image 120 using a generative model. Based on these checks, image processing apparatus 100 identifies information from initial caption 125 that are inaccurate. Image processing apparatus 100 then generates and outputs corrected caption 130, which excludes the inaccurate information.

In some embodiments, one or more components of image processing apparatus 100 are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 is configured to store information used by the image processing system. For example, database 105 may store model parameters, embeddings, generated texts, generated images, generated videos, user configuration settings, user activity history, model training data, and the like. A database is an organized collection of data. For example, a database stores data in a specified format known as a schema. A database may be structured as a single database, a distributed database, multiple distributed databases, or an emergency backup database. In some cases, a database controller may manage data storage and processing in a database. In some cases, a user interacts with the database controller. In other cases, the database controller may operate automatically without user interaction.

Network 110 facilitates the transfer of information between image processing apparatus 100, database 105, and user 115. In some cases, network 110 is referred to as a “cloud.” A cloud is a computer network configured to provide on-demand availability of computer system resources, such as data storage and computing power. In some examples, the cloud provides resources without active management by the user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

FIG. 2 shows an example of image processing apparatus 200 according to aspects of the present disclosure. The example shown includes image processing apparatus 200, processor 205, memory 210, user interface 215, language generation models 220, and multimodal language model 235.

Image processing apparatus 200 is an example of, or includes aspects of, the corresponding element described with reference to FIG. 1. Decomposer model 225 is an example of, or includes aspects of, the corresponding element described with reference to FIG. 6. Corrector model 230 is an example of, or includes aspects of, the corresponding element described with reference to FIGS. 5 and 6. Multimodal language model 235 is an example of, or includes aspects of, the corresponding element described with reference to FIGS. 4, 6, and 8. Generative model 240 is an example of, or includes aspects of, the corresponding element described with reference to FIG. 4. Fact-checker component 245 is an example of, or includes aspects of, the corresponding element described with reference to FIG. 4.

A processor 205 is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). The processor 205 may be configured to perform millions or billions of tensor operations per second, enabling real-time processing of complex visual data through parallel computation paths. In some cases, the processor 205 is configured to operate a memory 210 array using a memory controller. In other cases, a memory controller is integrated into the processor 205. In some cases, the processor 205 is configured to execute computer-readable instructions stored in a memory 210 to perform various functions. In some embodiments, a processor 205 includes special purpose components for visual data processing, neural network acceleration, or multi-agent coordination.

Examples of a memory 210 device include random access memory (RAM), read-only memory (ROM), or a hard disk. Examples of memory devices include solid state memory and a hard disk drive. In some examples, memory 210 is used to store computer-readable, computer-executable software including instructions that, when executed, cause processor 205 to perform various functions described herein. In some cases, memory 210 contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within memory 210 store information in the form of a logical state.

A user interface 215 enables a user to interact with image processing apparatus 200. In some embodiments, user interface 215 includes an audio device, such as an external speaker system, an external display device such as a display screen, or an input device (e.g., remote control device interfaced with the user interface 215 directly or through an IO controller module). In some cases, user interface 215 includes a graphical user interface (GUI).

Language generation models 220 are configured to generate text outputs. Embodiments of language generation models 220 include, for example, a large language model (LLM). The image processing apparatus 200 may include one language generation model configured to perform multiple tasks or may utilize multiple specialized language generation models. In one aspect, language generation models 220 includes decomposer model 225 and corrector model 230.

Decomposer model 225 is configured to “decompose” an initial caption into multiple partial captions. The initial caption may include multiple elements from an image, and the partial captions may be atomic propositions that each include only one element. For example, for an initial caption of “the image depicts a sidewalk adjacent to a grassy field, along with an octagonal sign that says ‘Stop’”, the decomposer model 225 may generate partial captions including: “the image includes a sidewalk”, “the image includes a grassy field”, “the image includes a sign”, “the sign in the image is octagonal”, “the image includes a sign that says ‘Stop’”.

Corrector model 230 is a language generation model that generates a corrected caption based on an initial caption, where the corrected caption keeps correct information from the initial caption and excludes inaccurate information. The corrector model 230 may be provided with the initial caption, partial captions, and hallucination labels respectively corresponding to the partial captions.

Multimodal language model 235, sometimes referred to as a multimodal large language model (MLLM), is configured to process an input image and an input text and generate an output text. Multimodal language model 235 may, for example, process the input image and a query asking a question about the input image, and generate an output text answering the query. Embodiments of multimodal language model include an LLM component, and a vision encoder that is finetuned to align with the LLM component. For example, the vision encoder may be based on a vision transformer (ViT) backbone and may be configured to output embeddings in the same input processing space as the inputs to the LLM.

In one aspect, multimodal language model 235 includes generative model 240 and fact-checker component 245. The generative model 240 may include the MLLM, which is configured to autoregressively generate output tokens based on text and visual inputs. The output tokens may be generated by selecting the token with the highest probability value at a classification head of the MLLM. The fact-checker component 245 may be configured to process these output probabilities directly to generate hallucination scores and labels for partial captions.

According to some aspects, fact-checker component 245 generates a hallucination label for each of the set of partial captions, where the output caption is generated based on the hallucination label. In some examples, fact-checker component 245 generates a hallucination score for each of the partial captions, where the hallucination label is based on the hallucination score. In some examples, fact-checker component 245 compares the hallucination score to a threshold value, where the hallucination label is based on the comparison. In some aspects, the hallucination label indicates a likelihood that the partial caption is a hallucination. Additional detail regarding this process is described with reference to FIG. 4.

In operation, the models and components described above may be implemented as specialized processing pipelines within the image processing apparatus 200. For example, decomposer model 225 and corrector model 230 may share underlying model weights and parameters stored in memory, while maintaining separate processing pathways and dedicated memory buffers for their respective tasks. The multimodal language model 235 may utilize specialized hardware acceleration for both its vision processing components and language modeling components, with dedicated data pathways between them to minimize latency during the verification of partial captions. These components may be implemented using various combinations of hardware and software optimizations, including but not limited to parallel processing units, specialized memory architectures, and hardware-accelerated matrix operations.

Each component of the system may include dedicated hardware resources. For example, language generation models 220 and multimodal language model 235 may each have their own dedicated memory devices (labeled ‘MEM’ in FIG. 2) which store model parameters, weights, and configurations specific to their respective functions. These dedicated memory devices may be optimized for the specific processing requirements of each model, such as high-bandwidth memory for vision processing or low-latency memory for dedicated decomposing operations. Fact-checker component 245 may utilize dedicated memory for storing token probability thresholds and temporary computation results during hallucination score determination. Dedicated hardware architecture may enable parallel processing across multiple models while minimizing memory access bottlenecks. For example, the decomposer model 225 may process an initial caption into a plurality of partial captions, and the multimodal language model 235 may evaluate partial captions against the image as they are generated.

The system may employ specialized hardware configurations to optimize performance. For example, multimodal language model 235 may utilize dedicated neural processing units (NPUs) or tensor processing units (TPUs) for efficient execution of computer vision operations. The system may include specialized matrix multiplication units to accelerate the token probability computations performed by fact-checker component 245, which may process tensors produced by generative model 240. Language generation models may utilize dedicated processing units optimized for natural language tasks, such as specialized attention mechanism hardware for processing sequential text data. The system may also include hardware-level synchronization mechanisms to ensure coherent operation across multiple processing units working in parallel, particularly when coordinating the sequential verification of partial captions. In some embodiments, the system includes dedicated data pathways between multimodal language model 235 and language generation models 220 to efficiently transmit hallucination scores and labels.

Some embodiments of image processing apparatus 200 include hardware configured to optimize hallucination reduction by providing dedicated circuits for managing the decomposition and verification pipeline. For example, dedicated cache hierarchies may be used to store frequently accessed partial captions and their corresponding verification results. The system may include dedicated hardware queues for managing the flow of partial captions between the decomposer model and the multimodal language model for efficient processing of partial captions. Additionally, specialized hardware may be used for parallel computation of hallucination scores across multiple partial captions, thereby enabling efficient scaling of the verification process to larger initial captions.

Components of image processing apparatus, such as language generation models 220 and multimodal language model 235, may implement a transformer. A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

In language models, the transformer architecture enables processing of variable-length text sequences through self-attention mechanisms. The model processes input text by converting words or subwords into embeddings and applying multiple layers of self-attention and feed-forward neural networks. Each layer allows the model to learn increasingly complex relationships between words in the input sequence. The self-attention mechanism enables the model to weigh the importance of different words in the context when predicting the next word or performing other language tasks. This architecture can be scaled to handle large amounts of text data by increasing the number of parameters, layers, and attention heads, leading to improved performance on various natural language processing tasks such as text generation, translation, and comprehension.

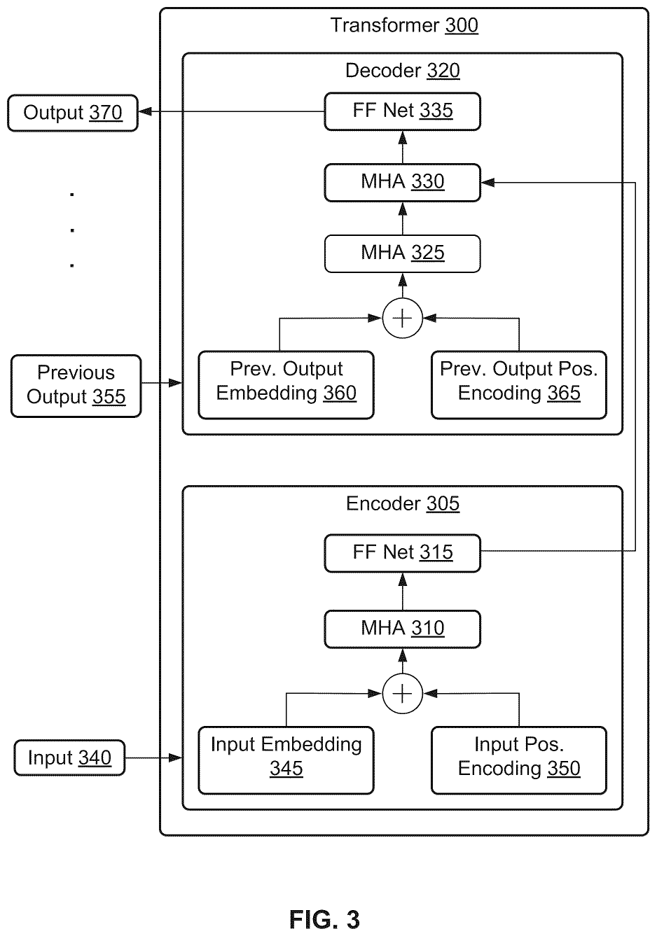

Multimodal large language models (MLLMs) extend the transformer architecture to process both text and other modalities such as images or audio. One implementation approach involves using separate encoders for different modalities, such as a vision encoder for processing images and a language model for processing text. The vision encoder converts visual information into a dense vector representation in the same dimensional space as the text embeddings. A modality interface or connector then aligns these representations with the language model's embedding space, allowing the model to process both modalities coherently. The language model can then generate text outputs based on both the visual and textual inputs it receives. This architecture enables the model to perform tasks that require understanding and generating text based on multiple types of input, such as answering questions about images or generating descriptions of visual content. Additional detail regarding an example transformer architecture is described with reference to FIG. 3.

FIG. 3 shows an example of a transformer network according to aspects of the present disclosure. The example shown includes transformer 300, encoder 305, decoder 320, input 340, input embedding 345, input positional encoding 350, previous output 355, previous output embedding 360, previous output positional encoding 365, and output 370.

In some cases, encoder 305 includes multi-head self-attention sublayer 310 and feed-forward network sublayer 315. In some cases, decoder 320 includes first multi-head self-attention sublayer 325, second multi-head self-attention sublayer 330, and feed-forward network sublayer 335.

According to some aspects, a machine learning model (such as the language generation model(s) and the multimodal language model described with reference to FIG. 2) comprises transformer 300. In some cases, encoder 305 is configured to map input 340 (for example, a query or a prompt comprising a sequence of words or tokens) to a sequence of continuous representations that are fed into decoder 320. In some cases, decoder 320 generates output 370 (e.g., a prediction of an output sequence of words or tokens) based on the output of encoder 305 and previous output 355 (e.g., a previously predicted output sequence), which allows for the use of autoregression.

For example, in some cases, encoder 305 parses input 340 into tokens and vectorizes the parsed tokens to obtain input embedding 345, and adds input positional encoding 350 (e.g., positional encoding vectors for input 340 of a same dimension as input embedding 345) to input embedding 345. In some cases, input positional encoding 350 includes information about relative positions of words or tokens in input 340.

In some cases, encoder 305 comprises one or more encoding layers (e.g., six encoding layers) that generate contextualized token representations, where each representation corresponds to a token that combines information from other input tokens via self-attention mechanism. In some cases, each encoding layer of encoder 305 comprises a multi-head self-attention sublayer (e.g., multi-head self-attention sublayer 310). In some cases, the multi-head self-attention sublayer implements a multi-head self-attention mechanism that receives different linearly projected versions of queries, keys, and values to produce outputs in parallel. In some cases, each encoding layer of encoder 305 also includes a fully connected feed-forward network sublayer (e.g., feed-forward network sublayer 315) comprising two linear transformations surrounding a Rectified Linear Unit (ReLU) activation:

$$FFN ( x ) = ReLU ( {W}_{1} x + {b}_{1} ) {W}_{2} + {b}_{2} \qquad ( 1 )$$

In some cases, each layer employs different weight parameters (W₁, W₂) and different bias parameters (b₁, b₂) to apply a same linear transformation to each word or token in input 340. As described with reference to FIG. 2, a multimodal encoder may generate tokens interpretable by the transformer from data of different modalities, such as image data, sound data, and video data. A connector network may project these tokens into the same embedding space as other modalities, e.g., the tokens representing text.

In some cases, each sublayer of encoder 305 is followed by a normalization layer that normalizes a sum computed between a sublayer input x and an output sublayer (x) generated by the sublayer:

$$layernorm ( x + sublayer ( x ) ) \qquad ( 2 )$$

In some cases, encoder 305 is bidirectional because encoder 305 attends to each word or token in input 340 regardless of a position of the word or token in input 340.

In some cases, decoder 320 comprises one or more decoding layers (e.g., six decoding layers). In some cases, each decoding layer comprises three sublayers including a first multi-head self-attention sublayer (e.g., first multi-head self-attention sublayer 325), a second multi-head self-attention sublayer (e.g., second multi-head self-attention sublayer 330), and a feed-forward network sublayer (e.g., feed-forward network sublayer 335). In some cases, each sublayer of decoder 320 is followed by a normalization layer that normalizes a sum computed between a sublayer input x and an output sublayer (x) generated by the sublayer.

In some cases, decoder 320 generates previous output embedding 360 of previous output 355 and adds previous output positional encoding 365 (e.g., position information for words or tokens in previous output 355) to previous output embedding 360. In some cases, each first multi-head self-attention sublayer receives the combination of previous output embedding 360 and previous output positional encoding 365 and applies a multi-head self-attention mechanism to the combination. In some cases, for each word in an input sequence, each first multi-head self-attention sublayer of decoder 320 attends only to words preceding the word in the sequence, and so transformer 300's prediction for a word at a particular position only depends on known outputs for a word that came before the word in the sequence. For example, in some cases, each first multi-head self-attention sublayer implements multiple single-attention functions in parallel by introducing a mask over values produced by the scaled multiplication of matrices Q and K by suppressing matrix values that would otherwise correspond to disallowed connections.

In some cases, each second multi-head self-attention sublayer implements a multi-head self-attention mechanism similar to the multi-head self-attention mechanism implemented in each multi-head self-attention sublayer of encoder 305 by receiving a query Q from a previous sublayer of decoder 320 and a key K and a value V from the output of encoder 305, allowing decoder 320 to attend to each word in the input 340.

In some cases, each feed-forward network sublayer implements a fully connected feed-forward network similar to feed-forward network sublayer 315. In some cases, the feed-forward network sublayers are followed by a linear transformation and a softmax function to generate a prediction of output 370 (e.g., a prediction of a next word or token in a sequence of words or tokens). According to some aspects, this prediction of a next word or token is generated in the form of a probability distribution over a token vocabulary, and this probability distribution is used utilized directly by embodiments herein to compute a hallucination score and subsequently a hallucination label.

FIG. 4 shows an example of a pipeline for fact-checking according to aspects of the present disclosure. The example shown includes image 400, partial caption 405, multimodal language model 410, generative model 415, probability True 420, probability False 425, fact-checker component 430, hallucination score 435, threshold check operation 440, and hallucination label 445.

Image 400 is an example of, or includes aspects of, the corresponding element described with reference to FIGS. 1, 6, and 8. Multimodal language model 410 is an example of, or includes aspects of, the corresponding element described with reference to FIGS. 2, 6, and 8. Generative model 415 is an example of, or includes aspects of, the corresponding element described with reference to FIG. 2. Fact-checker component 430 is an example of, or includes aspects of, the corresponding element described with reference to FIG. 2.

In this example, a decomposer model such as the one described with reference to FIG. 2 has already decomposed an input caption into a plurality of partial captions. For each partial caption, the partial caption 405 is input along with image 400 to multimodal language model 410 to determine if the element from partial caption 405 is actually present in image 400. This is referred to herein as the “isolation approach,” and is shown by evidence to have a much higher accuracy as compared to directly evaluating a large caption alone. In some embodiments, the partial caption 405 is prepended with “True or False?” to prompt the multimodal language model 410 to evaluate the image 400 to determine if the element is present therein.

The multimodal language model 410 includes generative model 415 and fact checker-component 430. The generative model 415 is an MLLM configured to process the image 400 and the partial caption 405 (prepended with “True or False”), and to generate the next token in sequence. When prompted with “True or False”, the next token will be, with extremely high probability, either the token corresponding to “True” if the element is included in the image or “False” if the element is not. Embodiments directly access these probabilities to obtain p (“True”) and p (“False”). For example, the MLLM may output token probabilities for all possible tokens from a token vocabulary, but embodiments may cache the probabilities corresponding to the tokens for “True” and “False” only.

According to some aspects, fact-checker component 430 computes a hallucination score based on the obtained token probabilities to predict if the element from partial caption 405 was hallucinated or not. For example, fact-checker component 430 may determine the hallucination score based on the following equation:

$$H ( u ) = - log ( min ( p ( “ True ” \vert x , Q ( u ) ) - p ( “ False ” \vert x , Q ( u ) ) , ϵ ) ) \qquad ( 3 )$$

where the hallucination score H for partial caption u is determined based on the token probabilities for “True” and “False” tokens. Q (u) represents the prepending operation on partial caption u. x is the input image. According to some aspects, generative model 415 provides two probability scores: one indicating its confidence that the statement is true p (“True” |x, Q (u)), and another indicating its confidence that the statement is false p (“False” |x, Q (u)). The calculation subtracts the “False” probability from the “True” probability, creating a confidence differential that ranges from −1 (completely false) to 1 (completely true). Embodiments may bound this difference by a small positive number e near zero to prevent mathematical issues with extremely small values. Finally, the negative logarithm of this bounded difference is taken, which converts the confidence scale into a hallucination score where higher values indicate a greater likelihood of hallucination.

For example, if system is very confident a statement is true (say 0.9 probability for “True” and 0.1 for “False”), the difference would be 0.8, and the negative logarithm of this value would yield a low hallucination score. Conversely, if the model thinks a statement is likely false (say 0.2 for “True” and 0.8 for “False”), the difference would be −0.6, which would be adjusted to E, and the negative logarithm would yield a high hallucination score. The system uses a threshold value x to sort caption fragments into two sets: set T contains fragments with hallucination scores below I (considered factual), while set F contains fragments with scores above x (considered potential hallucinations). Accordingly, the threshold check operation 440 sorts every partial caption into a predicted hallucination, assigning it hallucination label 445. These labels are stored for every partial caption and may be combined with the partial caption to form an input to a corrector model which will regenerate a caption for image 400 that omits the predicted hallucinations.

FIG. 5 shows an example of a pipeline for assembling a corrected caption 520 according to aspects of the present disclosure. The example shown includes partial captions 500, hallucination labels 505, initial caption 510, corrector model 515, and corrected caption 520.

Partial captions 500 is an example of, or includes aspects of, the corresponding element described with reference to FIG. 6. Hallucination labels 505 is an example of, or includes aspects of, the corresponding element described with reference to FIG. 6. Initial caption 510 is an example of, or includes aspects of, the corresponding element described with reference to FIGS. 1 and 6. Corrector model 515 is an example of, or includes aspects of, the corresponding element described with reference to FIGS. 2 and 6. Corrected caption 520 is an example of, or includes aspects of, the corresponding element described with reference to FIGS. 1 and 6.

According to some aspects, corrector model 515 generates corrected caption 520 based on partial captions 500, hallucination labels 505, and initial caption 510. The corrector model 515 may be configured through various approaches to perform this task. For example, the corrector model 515 may be directed through a pre-training process to generate captions that maintain factual elements and exclude hallucinated elements based on labeled data. In other examples, the corrector model 515 may be directed through a prompt, such as “Based on the given propositions and their corresponding True/False labels, correct the caption.” The corrector model 515 processes these inputs to generate corrected caption 520, which maintains the structure and style of initial caption 510 while excluding elements that were identified as hallucinations through the fact-checking process described with reference to FIG. 4.

During operation, the corrector model 515 may analyze the relationship between partial captions 500 and their corresponding hallucination labels 505 to understand which elements from the initial caption 510 should be preserved or removed. The corrected caption 520 preserves the natural language flow of the initial caption while ensuring that only verified elements are included in the final description.

FIG. 6 shows an example of a pipeline for correcting an initial caption using LLM-MLLM collaboration according to aspects of the present disclosure. The example shown includes image 600, initial caption 605, decomposer model 610, partial captions 615, prepend “True or False?” operation 620, multimodal language model 625, hallucination labels 630, corrector model 635, and corrected caption 640.

Image 600 is an example of, or includes aspects of, the corresponding element described with reference to FIGS. 1, 4, and 8. Initial caption 605 is an example of, or includes aspects of, the corresponding element described with reference to FIGS. 1 and 5. Decomposer model 610 is an example of, or includes aspects of, the corresponding element described with reference to FIG. 2. Partial captions 615 is an example of, or includes aspects of, the corresponding element described with reference to FIG. 5. Multimodal language model 625 is an example of, or includes aspects of, the corresponding element described with reference to FIGS. 2, 4, and 8. Hallucination labels 630 is an example of, or includes aspects of, the corresponding element described with reference to FIG. 5. Corrector model 635 is an example of, or includes aspects of, the corresponding element described with reference to FIGS. 2 and 5. Corrected caption 640 is an example of, or includes aspects of, the corresponding element described with reference to FIGS. 1 and 5.

According to some aspects, image 600 depicts a concrete sidewalk with text sprayed or etched onto the surface that reads “please walk bikes.” Initial caption 605, which includes inaccurate information about a rectangular green sign, is provided as input to both decomposer model 610 and corrector model 635. Decomposer model 610 processes initial caption 605 to generate partial captions 615, where each partial caption contains a single factual assertion about the image. For example, one partial caption may assert the presence of a rectangular sign, though it is apparent to a human observer that the rectangular sign is a hallucination.

The system processes each partial caption through prepend “True or False?” operation 620, which modifies the partial captions into a format suitable for verification. These modified partial captions, along with image 600, are input to multimodal language model 625. The multimodal language model 625 evaluates each assertion against the actual content of image 600, generating hallucination labels 630 through the process described with reference to FIG. 4.

Corrector model 635 receives three inputs: the initial caption 605, partial captions 615, and their corresponding hallucination labels 630. Based on these inputs, corrector model 635 generates corrected caption 640, which preserves the accurate elements of the initial caption while excluding the hallucinated elements, such as the non-existent rectangular green sign. Accordingly, embodiments are configured to remove hallucinations from captions of visual content, such as images and videos.

As described with reference to FIG. 2, embodiments may employ dedicated hardware resources for decomposer model 610, multimodal language model 625, and corrector model 635. For example, each model may utilize specialized processing units and dedicated memory to optimize parallel processing of caption elements. The system may employ memory pipelining techniques, such as double buffering between the decomposer and fact-checking stages, to efficiently utilize memory bandwidth and increase inference speed. Additionally, specialized cache hierarchies may be implemented to store frequently accessed partial captions and verification results. This improved framework for accurate image captioning enables various practical applications, such as providing reliable image descriptions for visually impaired users, generating accurate metadata for image databases, and enhancing content moderation systems. The correction framework described herein may be extended beyond image captioning to other applications that require precise visual understanding, such as robotic automation systems that need to verify object presence before manipulation, autonomous vehicle systems that must accurately identify road features and signage, quality control systems in manufacturing that verify product features, and computer-aided medical diagnosis systems that require accurate identification of visual features. Embodiments thus provide an extendable framework with the ability to decompose, verify, and reconstruct information may also be applied to other multimodal tasks such as video description, scene understanding, and augmented reality applications.

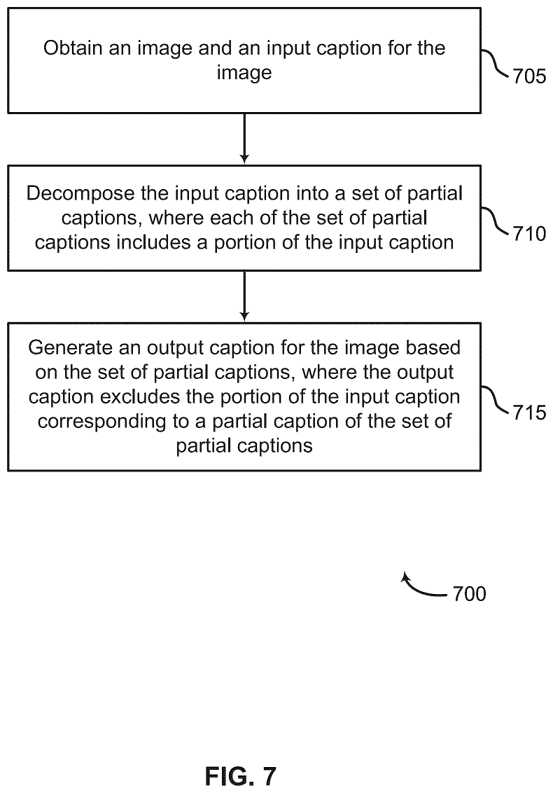

FIG. 7 shows an example of a method 700 for removing hallucinations from an initial caption according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps or are performed in conjunction with other operations.

At operation 705, the system obtains an image and an input caption for the image. In some cases, the operations of this step refer to, or may be performed by, an image processing apparatus as described with reference to FIGS. 1 and 2. The image processing apparatus may obtain these inputs from a user, or via an external automated system such as a system configured to process batches of captions to reduce their hallucinations. For example, the system may be used to improve the quality of training datasets by removing hallucinated content from image captions, or to verify and correct captions generated by other image captioning systems. The inputs may be received through a network interface, read from a storage device, or obtained through an API.

At operation 710, the system decomposes the input caption into a set of partial captions, where each of the set of partial captions includes a portion of the input caption. In some cases, the operations of this step refer to, or may be performed by, a language generation model as described with reference to FIG. 2. The decomposition process may utilize natural language processing techniques to identify distinct elements within the input caption, such as objects, attributes, and relationships. Each partial caption is formulated as an atomic proposition that can be independently verified against the image. For example, a caption describing multiple objects may be decomposed into separate partial captions, each describing a single object or attribute.

At operation 715 the system generates an output caption for the image based on the set of partial captions, where the output caption excludes the portion of the input caption corresponding to a partial caption of the set of partial captions. In some cases, the operations of this step refer to, or may be performed by, a corrector model as described with reference to FIGS. 2, 5, and 6. The corrector model receives the partial captions along with their corresponding hallucination labels and generates a new caption that preserves the accurate elements and excludes the hallucinated elements.

### Data Generation and Training Methods

FIG. 8 shows an example of a data generation pipeline for training data and evaluation data according to aspects of the present disclosure. The example shown includes image 800, captioning prompt 805, multimodal language model 810, predicted caption 815, item list prompt 820, language generation model 825, predicted items 830, expert evaluation 835, and hallucination labeled items 840.

Image 800 is an example of, or includes aspects of, the corresponding element described with reference to FIGS. 1, 4, and 6. Multimodal language model 810 is an example of, or includes aspects of, the corresponding element described with reference to FIGS. 2, 4, and 6.

The pipeline described with reference to FIG. 8 may be used to generate data that serves multiple purposes: evaluating the accuracy of existing multimodal language models for captioning tasks, generating training data for improving multimodal language models, and creating evaluation datasets for comparing different approaches to visual captioning. Multimodal language model 810 processes image 800 to generate a detailed description thereof, guided by captioning prompt 805 which may include directives such as “Describe the given image in a very detailed manner.” The system generates predicted caption 815, which is then provided to language generation model 825 for further processing.

Language generation model 825 receives item list prompt 820, which directs the model to decompose predicted caption 815 into predicted items 830. Each item in predicted items 830 represents a distinct element described in the caption, such as objects, attributes, or relationships identified in the image. For example, predicted items 830 may include elements such as “serpent,” “flower,” and “gray stone,” where subsequent verification reveals that at least “serpent” and “flower” are hallucinations that aren't based on image 800. The system subjects predicted items 830 to expert evaluation 835, wherein one or more experts assign hallucination labels to each item. These experts may be human annotators or more sophisticated visual processing systems configured to verify image content. The resulting hallucination labeled items 840 may be utilized to fine-tune multimodal language model 810 through backpropagation of the differences between predicted items 830 and hallucination labeled items 840, or to evaluate the accuracy of existing captioning systems and approaches.

FIG. 9 shows an example of evaluation metrics of different hallucination detection methods according to aspects of the present disclosure. The example shown includes confidence method 900, consistency method 905, object detector model method 910, and isolation (present embodiments) 915 method.

The evaluation metrics include Area Under the Receiver Operating Characteristic (AUROC) and False Positive Rate at 95% true positive rate (FPR95) for each method. According to some aspects, confidence method 900 represents a conventional approach that uses token probabilities during caption generation to detect hallucinations. Consistency method 905 represents another conventional approach that generates multiple captions for the same image and measures consistency across generations. Object detector model method 910 represents an approach that employs a dedicated object detection model to verify caption contents.

Isolation method 915, which corresponds to embodiments of the present disclosure, demonstrates superior performance compared to conventional approaches. For example, isolation method 915 achieves an AUROC of 81.4, representing a significant improvement over the AUROC values of 57.5, 73.5, and 61.5 achieved by confidence method 900, consistency method 905, and object detector model method 910, respectively. Similarly, isolation method 915 achieves an FPR95 of 71.7, showing improved performance compared to the FPR95 values of 95.0, 75.6, and 95.7 achieved by the conventional methods. These results demonstrate the effectiveness of decomposing captions into atomic units for individual verification.

### Training Methods

FIG. 10 is a flow diagram depicting an algorithm as a step-by-step procedure 1000 in an example implementation of operations performable for training a machine-learning model. In some embodiments, the procedure 1000 describes operations applicable to training, e.g., language generation models and multimodal language models as described with reference to FIG. 2. The procedure 1000 provides one or more examples of generating training data, use of the training data to train a machine-learning model, and use of the trained machine-learning model to perform a task. In some cases, the training operations may be applied to a pre-trained “foundation model” to specialize the model to excel at a more specific task.

To begin in this example, a machine-learning system collects training data (block 1002) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine-learning system is also configurable to identify features that are relevant (block 1004) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 1006). Initialization of the machine-learning model includes selecting a model architecture (block 1008) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1010). The loss function is utilized to measure a difference between an output of the machine-learning model (i.e., predictions) and target values (e.g., as expressed by the training data) to be used to train the machine-learning model. Additionally, an optimization algorithm is selected (1012) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 1014) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 1018) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 1020), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1020), the procedure 1000 continues training of the machine-learning model using the training data (block 1010) in this example.

If the stopping criterion is met (“yes” from decision block 1020), the trained machine-learning model is then utilized to generate an output based on subsequent data (block 1022). The trained machine-learning model, for instance, is trained to perform a task as described above and therefore, once trained is configured to perform that task based on subsequent data received as an input and processed by the machine-learning model.

### Computing Device

FIG. 11 shows an example of a computing device 1100 according to aspects of the present disclosure. The example shown includes computing device 1100, processor(s) 1105, memory subsystem 1110, communication interface 1115, I/O interface 1120, user interface component(s), and channel 1130.

In some embodiments, computing device 1100 is an example of, or includes aspects of, an image processing apparatus as described in FIGS. 1 and 2. In some embodiments, computing device 1100 includes one or more processors 1105 are configured to execute instructions stored in memory subsystem 1110 to obtain an image and an input caption for the image; decompose, using a language generation model, the input caption into a plurality of partial captions, wherein each of the plurality of partial captions includes a portion of the input caption; and generate an output caption for the image based on the plurality of partial captions, wherein the output caption excludes the portion of the input caption corresponding to a partial caption of the plurality of partial captions.

According to some aspects, computing device 1100 includes one or more processors 1105. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1110 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1115 operates at a boundary between communicating entities (such as computing device 1100, one or more user devices, a cloud, and one or more databases) and channel 1130 and can record and process communications. In some cases, communication interface 1115 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1120 is controlled by an I/O controller to manage input and output signals for computing device 1100. In some cases, I/O interface 1120 manages peripherals not integrated into computing device 1100. In some cases, I/O interface 1120 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1120 or via hardware components controlled by the I/O controller.

According to some aspects, user interface component(s) 1125 enable a user to interact with computing device 1100. In some cases, user interface component(s) 1125 include an audio device, such as an external speaker system, an external display device such as a display screen, an input device (e.g., a remote-control device interfaced with a user interface directly or through the I/O controller), or a combination thereof. In some cases, user interface component(s) 1125 include a GUI.

Accordingly, the present disclosure includes the following aspects.

A method for image captioning is described. One or more aspects of the method include obtaining an image and an input caption for the image; decomposing, using a language generation model, the input caption into a plurality of partial captions, wherein each of the plurality of partial captions includes a portion of the input caption; and generating an output caption for the image based on the plurality of partial captions, wherein the output caption excludes the portion of the input caption corresponding to a partial caption of the plurality of partial captions.

Some examples of the method, apparatus, non-transitory computer readable medium, and system further include generating a hallucination label for each of the plurality of partial captions, wherein the output caption is generated based on the hallucination label. Some examples further include generating a hallucination score for each of the plurality of partial captions, wherein the hallucination label is based on the hallucination score. Some examples further include comparing the hallucination score to a threshold value, wherein the hallucination label is based on the comparison.

Some examples of the method, apparatus, non-transitory computer readable medium, and system further include comparing the partial caption to the image, wherein the hallucination label is based on the comparison. In some aspects, the hallucination label indicates a likelihood that the partial caption is a hallucination.

A method for image captioning is described. One or more aspects of the method include obtaining an image and an input caption for the image; generating, using a multimodal language model, a hallucination label corresponding to a portion of the input caption; and generating an output caption for the image based on the hallucination label, wherein the output caption excludes the portion of the input caption.

Some examples of the method, apparatus, non-transitory computer readable medium, and system further include decomposing, using a language generation model, the input caption into a plurality of partial captions, wherein the portion of the image caption is included in the plurality of partial captions. Some examples further include generating a hallucination score for each of the plurality of partial captions, wherein the hallucination label is based on the hallucination score.

Some examples of the method, apparatus, non-transitory computer readable medium, and system further include comparing the hallucination score to a threshold value, wherein the hallucination label is based on the comparison. Some examples further include comparing the partial caption to the image, wherein the hallucination label is based on the comparison. In some aspects, the hallucination label indicates a likelihood that the partial caption is a hallucination.

An apparatus for image captioning is described. One or more aspects of the apparatus include a memory component; a processing device coupled to the memory component, the processing device configured to perform operations comprising: obtaining an image and an input caption for the image; decomposing, using a language generation model, the input caption into a plurality of partial captions, wherein each of the plurality of partial captions includes a portion of the input caption; and generating an output caption for the image based on the plurality of partial captions, wherein the output caption excludes the portion of the input caption corresponding to a partial caption of the plurality of partial captions.

In some aspects, the language generation model comprises a transformer architecture. Some examples of the apparatus, system, and method further include a multimodal language model configured to generate a hallucination label corresponding to the partial caption. In some aspects, the multimodal language model is further configured to compare the partial caption to the image, wherein the hallucination label is based on the comparison. Some examples of the apparatus, system, and method further include comparing the hallucination score to a threshold value to generate a hallucination label.

In some aspects, the multimodal language model is further configured to generate a hallucination score for each of the plurality of partial captions, wherein the hallucination label is based on the hallucination score. In some aspects, the multimodal language model is configured to generate the input caption. Some examples of the apparatus, system, and method further include a corrector model configured to generate the output caption.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an image and an input caption for the image;
decomposing, using a language generation model, the input caption into a plurality of partial captions, wherein each of the plurality of partial captions includes a portion of the input caption; and
generating an output caption for the image based on the plurality of partial captions, wherein the output caption excludes the portion of the input caption corresponding to a partial caption of the plurality of partial captions.

2. The method of claim 1, further comprising:
generating a hallucination label for each of the plurality of partial captions, wherein the output caption is generated based on the hallucination label.

3. The method of claim 2, further comprising:
generating a hallucination score for each of the plurality of partial captions, wherein the hallucination label is based on the hallucination score.

4. The method of claim 3, further comprising:
comparing the hallucination score to a threshold value, wherein the hallucination label is based on the comparison.

5. The method of claim 2, further comprising:
comparing the partial caption to the image, wherein the hallucination label is based on the comparison.

6. The method of claim 2, wherein:
the hallucination label indicates a likelihood that the partial caption is a hallucination.

7. A non-transitory computer readable medium storing code for image processing, the code comprising instructions that, when executed by at least one processor, cause the at least one processor to perform operations comprising:
obtaining an image and an input caption for the image;
generating, using a multimodal language model, a hallucination label corresponding to a portion of the input caption; and
generating an output caption for the image based on the hallucination label, wherein the output caption excludes the portion of the input caption.

8. The non-transitory computer readable medium of claim 7, the code further comprising instructions that, when executed by the at least one processor, cause the at least one processor to perform operations comprising:
decomposing, using a language generation model, the input caption into a plurality of partial captions, wherein the portion of the image caption is included in the plurality of partial captions.

9. The non-transitory computer readable medium of claim 8, the code further comprising instructions that, when executed by the at least one processor, cause the at least one processor to perform operations comprising:
generating a hallucination score for each of the plurality of partial captions, wherein the hallucination label is based on the hallucination score.

10. The non-transitory computer readable medium of claim 9, the code further comprising instructions that, when executed by the at least one processor, cause the at least one processor to perform operations comprising:
comparing the hallucination score to a threshold value, wherein the hallucination label is based on the comparison.

11. The non-transitory computer readable medium of claim 7, the code further comprising instructions that, when executed by the at least one processor, cause the at least one processor to perform operations comprising:
comparing the partial caption to the image, wherein the hallucination label is based on the comparison.

12. The non-transitory computer readable medium of claim 7, wherein:
the hallucination label indicates a likelihood that the partial caption is a hallucination.

13. A system for image processing, comprising:
a memory component;
a processing device coupled to the memory component, the processing device configured to perform operations comprising:
obtaining an image and an input caption for the image;
decomposing, using a language generation model, the input caption into a plurality of partial captions, wherein each of the plurality of partial captions includes a portion of the input caption; and
generating an output caption for the image based on the plurality of partial captions, wherein the output caption excludes the portion of the input caption corresponding to a partial caption of the plurality of partial captions.

14. The system of claim 13, wherein:
the language generation model comprises a transformer architecture.

15. The system of claim 13, the system further comprising:
a multimodal language model configured to generate a hallucination label corresponding to the partial caption.

16. The system of claim 15, wherein:
the multimodal language model is further configured to compare the partial caption to the image, wherein the hallucination label is based on the comparison.

17. The system of claim 16, wherein:
the multimodal language model is further configured to generate a hallucination score for each of the plurality of partial captions, wherein the hallucination label is based on the hallucination score.

18. The system of claim 17, the processing device being further configured to perform operations comprising:
comparing the hallucination score to a threshold value to generate a hallucination label.

19. The system of claim 15, wherein:
the multimodal language model is configured to generate the input caption.

20. The system of claim 13, the system further comprising:
a corrector model configured to generate the output caption.
